(19) United States
(12) Patent Application Publication
(10) Pub. No.: US 2024/0406157 A1
(43) Pub. Date: Dec. 5, 2024

(54) ACCESS CONTROL SYSTEM

(71) Applicant: Saurer Spinning Solutions GmbH & Co. KG, Übach-Palenberg (DE)

(72) Inventors: Ulrich Gais, Herdecke (DE); Johannes Schmitz, Übach-Palenberg (DE)

(73) Assignee: Saurer Spinning Solutions GmbH & Co. KG, Übach-Palenberg (DE)

(21) Appl. No.: 18/676,881

(22) Filed: May 29, 2024

(30) Foreign Application Priority Data
May 31, 2023 (LU) 504358

(51) Int. Cl. H04L 9/40; G05B 19/4155

(52) U.S. Cl. CPC H04L 63/08; G05B 19/4155; H04L 63/102; G05B 2219/45196

(57) ABSTRACT

A system for access control, having a textile machine and a control system for monitoring and controlling the textile machine, the textile machine and the control system being arranged in a first communication network for transmitting control commands for controlling the textile machine. The system has an authentication system being arranged in a second communication network, and the authentication system being designed to authenticate at least one user in order to enable access for controlling the textile machine in the first communication network.

The present invention relates to a system of the type defined in more detail in the preamble of claim 1. The invention also relates to a method, a computer program and a device.

### PRIOR ART

Access to control a machine can usually be provided via a control unit that is integrated into the machine or is separate from the machine. The control unit can control and monitor various machine processes, such as the drive, speed, temperature or pressure. Modern control systems often also enable remote control so that the machine can be monitored and controlled from a remote location. However, the access rights to the control unit must be carefully managed to prevent unauthorized access to the machine and to ensure safe operation of the machine.

Access to the control unit can often only be protected by manually entering a user name and password. Managing access rights is complicated, time-consuming and is carried out manually on each individual machine by an appropriately authorized person. The user is identified by a time-consuming manual input of a user name and password, which can be forgotten by the user.

Therefore, it is an object of the present invention to at least partially eliminate the disadvantages described above. In particular, it is the object of the present invention to provide improved identification of the user with existing identification means. A further object of the present invention can be to ensure better and simpler administration of access rights with the support of existing authentication infrastructure.

### DISCLOSURE OF THE INVENTION

The invention relates to a system having the features of claim 1, to a method having the features of claim 11, to a computer program having the features of claim 14 and to a device having the features of claim 15. Further features and details of the invention are apparent from the respective subclaims, the description and the drawings. Features and details described in connection with the system according to the invention also apply of course in connection with the method according to the invention, the computer program according to the invention and the device according to the invention, and vice versa in each case, such that, with regard to the disclosure concerning the individual aspects of the invention, reference is or can always be made mutually.

The invention relates, in particular, to a system for access control, having a textile machine and a control system for monitoring and controlling the textile machine. The control system can, for example, be an electronic device that electrically controls the textile machine in order to configure and/or adjust the textile machine and/or transfer it to at least one operating state. In this case, the textile machine and the control system can be arranged in a first communication network for transmitting control commands, in particular control signals, for controlling the textile machine. The communication network is, for example, a network for data transmission to which both the textile machine and the control system can be connected. The system can also have an authentication system, the authentication system being arranged in a second communication network. The second communication network can also be a network for data transmission, but one which differs from the first communication network, preferably also in terms of network technology. It can be possible for the authentication system to be designed to authenticate at least one user in order to enable access for controlling the textile machine in the first communication network, preferably to enable access for the at least one user to set and/or configure production parameters for the textile machine. The advantage of this is that a resource-saving system for access control can be provided because existing authentication and/or identification means can be used to authenticate the at least one user. Furthermore, the invention enables better and simpler administration of access rights with the support of existing authentication infrastructure.

The control system can comprise a monitoring unit and a control unit for monitoring and controlling the textile machine. In particular, the monitoring unit can be designed as a central monitoring unit for one or more textile machines. The monitoring unit can comprise control and management software, which can be used in particular to monitor and configure the one or more textile machines. For example, parameters or settings for the textile machine can be monitored, changed and/or configured. This can then be initiated via corresponding control commands. The control unit of the control system can be arranged in or on a textile machine and can be provided for controlling the textile machine. The monitoring unit and the control unit can be provided as respective devices for user access to control the textile machine.

In the context of the invention, authentication can mean in particular that the identity of a user or an entity is checked in order to ensure that said person or entity is actually who they claim to be. This can be done by entering a user name and password or by using biometric features, such as fingerprints or facial recognition. Authentication in the context of the invention can also be understood to mean that a characteristic of the user, such as authority to control, is verified. Authentication is often used in computer systems and online services to control access to protected resources and prevent unauthorized access.

Access control refers in particular to measures or technologies that are used to restrict and control access to information, systems or physical spaces. The aim of access control is to prevent unauthorized access and ensure that only authorized users can access the required resources. Various mechanisms, such as passwords, biometric features and keys, can be used for this purpose.

A textile machine, such as a spooler or a spinning machine, can be used to spin fibers or yarns and/or wind them onto bobbins. The machine can comprise a device that allows fibers to be fed into the machine manually or automatically. The machine can have a spinning mechanism consisting of a spinning flyer or spindle which rotates at high speed. This allows the fibers to be drawn together and spun into yarn.

The setting of parameters for a textile machine, such as for a spooler and/or spinning machine, refers in particular to the adjustment of values that can be used, for example, in a textile-machine management system to change or adjust the behavior of the textile machine. Parameters can be used, for example, to reduce the time required to process requests or to control the number of simultaneously executed processes. Parameters can be set by a user to improve the performance or functionality of the application or system. The configuration of parameters, in contrast, refers in particular to the process of setting parameters that is normally carried out by the administrator or system administrator. The configuration of parameters involves setting parameters at the system level of a management system or textile machine level of the system in order to ensure that the textile machine is functioning properly and production requirements are being met.

A machine management system or mill management system can be in the form of a computer system that can be used to control and monitor production processes in the textile industry. This system can collect and analyze data from various sources, including machine controllers, sensors or manual inputs, to optimize production efficiency and productivity. Said system allows operators to obtain real-time information on the status of the textile machine and the progress of production, as well as to identify and rectify potential problems. A mill management system can also include functions, such as order planning, material and resource management, quality control and inventory management.

A further advantage can be achieved within the scope of the invention if the system has a sensor unit for acquiring identification data of the at least one user for authentication, the sensor unit being arranged in the first or in the second communication network. Arranging the sensor unit in the first communication network can have the advantage that the sensor unit is arranged closer to the textile machine and can communicate directly with the textile machine via the first communication network if necessary. It may also be possible for at least one existing sensor of the textile machine to be used as a sensor unit. Arranging the sensor unit in the second communication network can have the advantage that direct communication with the authentication system in the second communication network is possible and that existing authentication infrastructure can be utilized. Arrangement in the first or second communication network can mean that the sensor unit is integrated into the corresponding communication network as a network participant.

It is also advantageous if, within the scope of the invention, the sensor unit in the second communication network is designed to transmit the acquired identification data to the authentication system for authentication. It is also conceivable for the sensor unit in the first communication network to be designed to transmit the acquired identification data to the authentication system for authentication or to the control system for authentication. This enables authentication to be carried out efficiently and directly between the sensor unit and the authentication system.

Furthermore, the sensor unit can have a card reader and/or a fingerprint scanner and/or a retina scanner and/or a camera having face recognition and/or voice recognition. In more general terms, the sensor unit can be designed to detect at least one or more biometric features of the user. This can significantly increase the security and flexibility of the system.

Furthermore, within the scope of the invention, the system can have an interface which communicatively connects the textile machine and/or the control system in the first communication network to the authentication system in the second communication network. The interface can be designed to transmit authentication information from the authentication system to the textile machine and/or to the control system in order to enable or block control access for the at least one user. The authentication information can, for example, be transmitted to the control system so that the control system can first evaluate the authentication information in order to allow the textile machine to be controlled on the basis of the evaluation. For example, the control system can allow control only if the evaluation shows that the user is authorized to take control. The textile machine, in contrast, can respond to the control commands without actively taking the authentication information into account. This means that the textile machine can be manufactured independently of a specific authentication method. It is also conceivable for the textile machine to receive the authentication information and thus itself actively evaluate whether the control commands are being implemented. For example, the authentication information can also be added to the control commands so that the textile machine can check for each control command whether it is permitted to be implemented.

A further advantage can be achieved within the scope of the invention if the interface has a conversion unit which is designed to convert a data format and/or a network protocol of the authentication information when transmitted between the two communication networks for setting production parameters for the textile machine. This allows different network technologies to be used for the communication networks. This also allows the communication between the authentication system in the second communication network and the machine system comprising the textile machine and the control system in the first communication network to take place in a secure and interference-free manner via the interface. The interface makes it possible to ensure effective and interoperable communication in each communication network when there are different data format or network protocol requirements. This means that the interface advantageously ensures better interoperability between different network technologies and protocols, including for example the conversion of data between different network formats.

For example, the authentication information can comprise a communication message relating to enabling or blocking access of the at least one user for controlling the textile machine. It is also conceivable for the authentication information to comprise a communication message comprising one or more authorization profiles for the at least one user for the access, each authorization profile preferably defining a scope and/or configuration of the access for the particular user, in particular for controlling different functions of the textile machine and/or the control system. This allows the authentication system to flexibly adapt the communication within the system on the basis of different security requirements for authentication.

Furthermore, within the scope of the invention, the authentication system can have a database which comprises data for authenticating the at least one user for access, in particular access and/or authorization profiles for the at least one user. This has the advantage of enabling systematic organization and structuring of data; in particular, the database makes it easier to search for and access data and enables data to be stored more efficiently and more reliably. The database also provides a secure way to store and protect data. Users can control access rights to data in order to ensure the confidentiality and integrity of said data.

Preferably, within the scope of the invention, the textile machine can be a spooler or spinning machine, preferably an air-jet spinning machine or a rotor spinning machine or a ring spinning machine, the textile machine having a plurality of work stations arranged side by side, preferably spinning or winding stations, which are each designed to carry out at least one production step for producing a textile product, the control of the textile machine by the control system comprising at least one of the following actions in order to make the at least one action available to the user in the event of access being enabled:
setting at least one parameter of the textile machine,
setting at least one parameter of the work stations,
setting at least one parameter for production,
starting the textile machine, in particular the production,
setting a spinning means, a yarn parameter, a piecing parameter, a winding parameter or a cleaner parameter of the textile machine,
displaying measurement results from at least one sensor of the textile machine, activating or deactivating individual work stations,
calling up a graphical user interface for the textile machine.

This enables better access control and control of the textile machine in order to ensure efficient production, in particular of a spooler or spinning machine.

A further advantage can be achieved within the scope of the invention if the first communication network is a higher level communication network, and the second communication network is a machine communication network of the textile machine, the machine communication network being designed as a separate communication network to the first communication network and/or being subordinate to the first communication network and/or being designed as a sub-network of the first communication network, and/or in that the first and/or the second communication network comprises a wired and/or wireless communication network, preferably an Ethernet network and/or a fiber-optic network and/or a WLAN network and/or a ZigBee network and/or a Bluetooth network. Using two communication networks can increase security when carrying out authentication, since in particular one network can be used to transmit authentication requests and authentication responses, while the other network can be used to control access to the textile machine, for example. Furthermore, using two communication networks can contribute in particular to the authentication procedure running more efficiently.

The invention further relates to a method for access control for a system according to the invention, comprising the following steps:
receiving of an authentication request by an authentication system in a second communication network, the authentication request being used to request authentication of at least one user in order to enable access to the textile machine for the at least one user,
checking the received authentication request with respect to an access authorization of the at least one user,
granting access for the at least one user if the access authorization is confirmed by the check,
transmitting to the textile machine and/or to the control system and/or to the sensor unit the granting of access of the at least one user.

In this way, the method according to the invention brings the same advantages as have been described in detail with reference to the system according to the invention.

Furthermore, it is conceivable within the scope of the invention for the method to comprise the further following steps:
denying access for the at least one user for controlling the textile machine if the access authorization was rejected by the check,
   the following step being carried out in the event of denial:
transmitting to the textile machine and/or to the control system and/or to the sensor unit a blocking of access for the at least one user.

This makes it possible to ensure more effective control of access.

It is also advantageous if the method comprises at least one of the following steps:
transmitting to the textile machine and/or to the control system and/or to the sensor unit authentication information for authenticating access of the at least one user,
   the authentication information comprising a communication message relating to enabling or blocking access of the at least one user to the textile machine,
transmitting authentication information for authenticating the access of the at least one user to the control system, the authentication information comprising a communication message which comprises one or more access authorization profiles for the at least one user for evaluation by the control system,
acquiring identification data of the at least one user by means of the sensor unit, the acquired identification data being specific to an identification of the at least one user to an authorization profile or access profile for controlling different functions of the textile machine and/or the control system,
transmitting the received identification data to the authentication unit for authentication.

This has the advantage that access control can be carried out flexibly and efficiently.

The invention also relates to a computer program, in particular a computer program product, comprising commands which, when the computer program is executed by a computer, cause the computer to carry out the method according to the invention. In this way, the computer program according to the invention brings the same advantages as have been described in detail with reference to the system according to the invention and the method according to the invention.

The invention also relates to a device for data processing, in particular arranged at least partly in an authentication system and/or in a control system of the system according to the invention, comprising means for carrying out the method according to the invention. In this way, the device according to the invention brings the same advantages as have been described in detail with reference to the system according to the invention and the method according to the invention.

As the computer, a device for data processing can be provided, for example the device according to the invention which executes the computer program. The computer can have at least one processor for executing the computer program. A non-volatile data memory can also be provided, in which the computer program can be stored and from which the computer program can be read by the processor for execution.

It is also conceivable that the computer comprises at least one integrated circuit, such as a microprocessor or an application-specific integrated circuit (ASIC) or an application-specific standard product (ASSP) or a digital signal processor (DSP) or a field-programmable gate array (FPGA) or the like. The computer can further have at least one interface for data exchange, such as an Ethernet interface or an interface for LAN (local area network) or WLAN (wireless interface, such as Bluetooth or near-field communication (NFC). Further, the computer can be implemented as one or more control devices, i.e., also as a system of control devices. For example, the computer can also be provided in a cloud and/or as a server, in order to provide data processing for a local application via the interface. It is also possible that the computer is implemented as a mobile device, such as a smartphone.

An object of the invention can also be a computer-readable storage medium which comprises the computer program according to the invention. The storage medium is designed, for example, as a data storage, such as a hard disk and/or a non-volatile memory and/or a memory card. The storage medium can, for example, be integrated into the computer.

In addition, the method according to the invention can also be executed as a computer-implemented method.

Further advantages, features and details of the invention will be apparent from the following description, in which exemplary embodiments of the invention are described in detail with reference to the drawings. The features mentioned in the claims and in the description can be substantial to the invention individually or in any combination.

The following are shown:

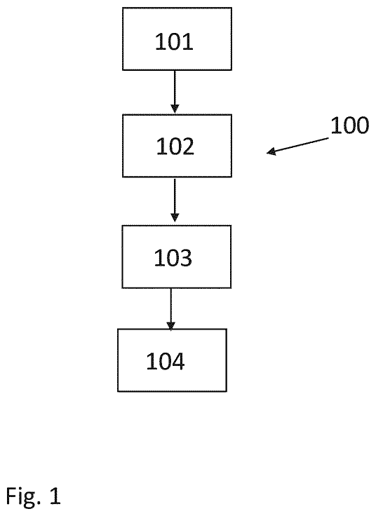

FIG. 1 schematically shows an exemplary embodiment of the method according to the invention,

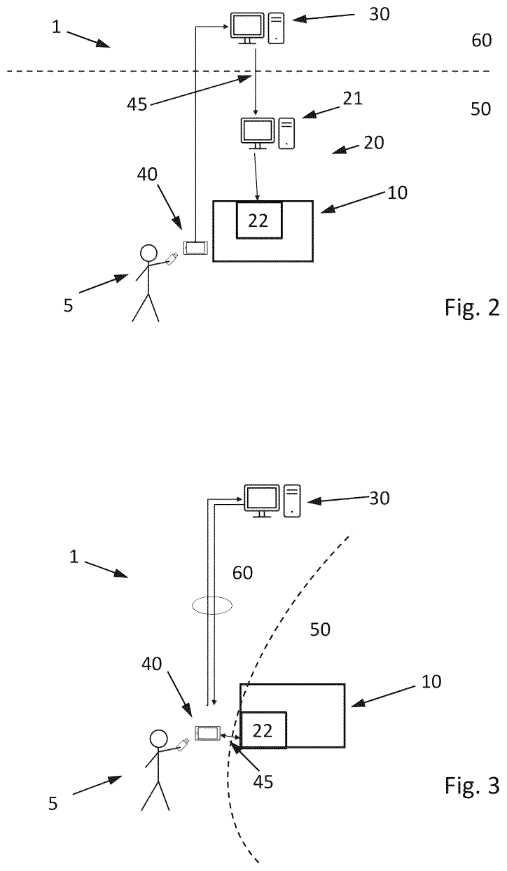

FIG. 2 schematically shows another exemplary embodiment of the method according to the invention and system according to the invention,

FIG. 3 schematically shows another exemplary embodiment of the method according to the invention and system according to the invention,

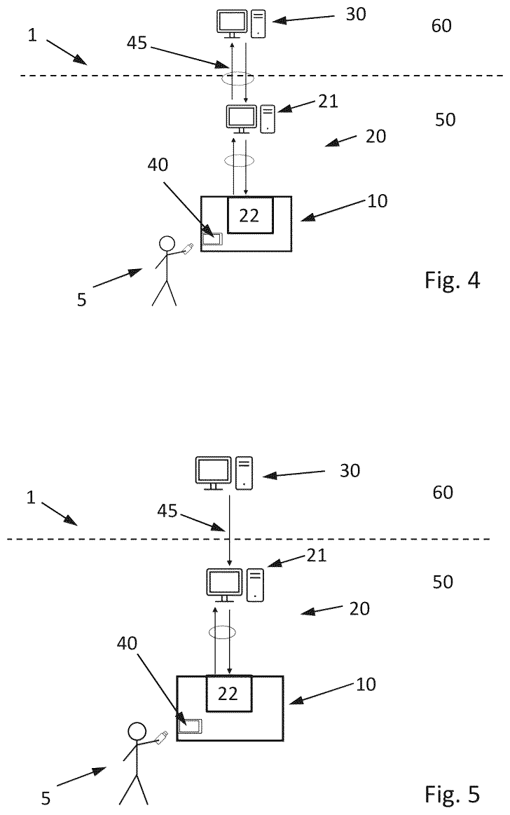

FIG. 4 schematically shows another exemplary embodiment of the method according to the invention and system according to the invention, and

FIG. 5 schematically shows another exemplary embodiment of the method according to the invention and system according to the invention.

In the following figures, the identical reference signs are used for the same technical features even of different exemplary embodiments.

The core of the invention is to provide a system 1 and a method 100 for controlling access to a textile machine 10, which system or method can access an existing authentication system 30, such as an access or entry system to a company building or premises, in order to allow a user 5 to access one or more textile machines 10 on the basis of user authorization profiles.

For example, a sensor system can be communicatively connected to a textile machine 10 and/or to a control system 20 for the textile machine 10. The control system 20 can, for example, comprise a monitoring unit 21 and a control unit 22. The monitoring unit 21 can comprise control and management software for monitoring and managing one or more textile machines 10. The monitoring unit 21 can be communicatively connected to the control unit 22, for example to transmit to the control unit 22 control commands for configuring and controlling the textile machine 10 or to receive these commands. The control unit 22 can be provided to control the textile machine 10, for example to control a production sequence. Furthermore, a user 5 can gain access to the control system 20 via the control unit 22. The user can be authenticated at the control system 20, for example at an operating computer 22 as the control unit 22 of the control system 20 for the textile machine 10, using existing data carriers, such as an RFID chip, a smart card, a smartphone or a USB stick. Alternatively, biometric data acquisition by a sensor unit 40 can be used, for example with a fingerprint scanner, a retina scanner or a camera having facial recognition and/or voice recognition, to authenticate the user 5 to control a textile machine 10, it being possible for the biometric data acquisition to already be used for the user 5 for access control or for time recording within the company or the company premises.

In other words, the textile machines 10 are connected—communicatively and for data transfer—to the control system 20, which in turn is connected—communicatively and for data transfer—to the customer's employee access/time recording system. The relevant data for authenticating the users 5 or company employees can be linked to the data of the textile machines 10 and can be used for the centralized definition, assignment and management of access rights and the authentication of users 5. In this way access can also be monitored.

For example, if a user 5 logs on to a sensor unit 40 of a textile machine 10, the access rights of the user 5 can be ascertained by the authentication system 30. The authentication system 30 can then decide upon enabling or blocking access to the connected textile machine 10 on the basis of the transmitted identification data and transmit a corresponding message to the control system 20, for example to the control unit 22.

FIG. 1 schematically shows an exemplary embodiment of the method 100 according to the invention. FIG. 1 shows a method 100 for access control for a system 1 according to the invention.

In a step 101, an authentication request is received by an authentication system 30 in a second communication network 60, the authentication request being used to request authentication of at least one user 5 in order to enable access to the textile machine 10 for the at least one user 5.

Subsequently, in step 102, the received authentication request is checked with respect to an access authorization of the at least one user 5.

In step 103, access is then granted for the at least one user 5 if the access authorization is confirmed by the check 102.

In step 104, the granting of access of the at least one user 5 is transmitted to the textile machine 10 and/or to the control system 20 and/or to the sensor unit 40.

FIG. 2 shows another exemplary embodiment of a method 100 and system 1 according to the invention.

The system 1 in FIG. 2 comprises a textile machine 10 and a control system 20 in a first communication network 50, which can be a machine network, for example. The control system 20 can comprise a monitoring unit 21 and a control unit 22. The monitoring unit 21 of the control system 20 can comprise control and management software for monitoring and managing one or more textile machines 10. FIG. 2 also shows an authentication system 30 for authenticating identification data of a user 5. The system 1 also has a sensor unit 40 for acquiring identification data of the user 5. The authentication system 30 is arranged in a second communication network 60, it being possible for the second communication network 60 to be, for example, a company network, which can be in the form of, e.g., a wired Ethernet communication network or a wireless WLAN communication network. The two communication networks 50, 60 are separate networks. The separate networks are necessary for data and security reasons in order to protect both company data and machine data against misuse and unauthorized access.

In the exemplary embodiment according to FIG. 2, for example, a user logs on to the sensor unit 40 with their company card, i.e., a smart card or chip card, the sensor unit 40 not being arranged in the machine network 50, but in the company network 60. The sensor unit 40 can be in the form of a card reader. The card reader 40 is arranged in the company network 60.

The sensor unit 40 transmits the data of the user 5 stored on the smart card, for example the identification data of the user, to the authentication system 30 to carry out the authentication.

The authentication system 30 checks the received identification data of the user 5 on the basis of a stored user profile of access rights and, based on this check, decides upon enabling or blocking access of the user 5 to the control system 20. In a further step, the authentication system 30 transmits authentication information in the form of a communication message that enables or blocks access of the second communication network 60 to the control system 20 in the first communication network 50, for example to the monitoring unit 21. The monitoring unit 21 can comprise control and management software for monitoring and managing one or more textile machines 10. After receiving the communication message, the monitoring unit 21 enables or blocks the user's access to the textile machine 10 on the basis of the check of the access authorization of the user 5.

FIG. 3 shows another exemplary embodiment of the method 100 and system 1 according to the invention. In this exemplary embodiment, the system 1 comprises a sensor unit 40 for acquiring identification data, the sensor unit 40 being arranged in the second communication network 60. The second communication network 60, which can be configured as shown in FIG. 2, further comprises an authentication system 30. The system also comprises a textile machine 10, the textile machine 10 being arranged in a first communication network 50. The system 1 also comprises a control unit 22 of the control system for the textile machine 10 and an interface 45 between the two communication networks 50, 60. In this exemplary embodiment, the interface 45 is used to enable or block access of the user 5 to control the textile machine.

In the exemplary embodiment shown in FIG. 3, the user 5 logs on to the sensor unit 40 with their company card, i.e., a smart card or chip card. In this step, the sensor unit 40 acquires the data of the user 5 that is on the smart card and transmits the acquired data as an authentication request to the authentication system 30 to carry out the authentication. The authentication system checks the transmitted identification data and decides whether to enable access of the user 5. The authentication information relating to enabling or blocking access can, for example, be transmitted to the sensor unit 40 as a communication message according to this exemplary embodiment. The sensor unit 40 transmits the authentication information via the interface 45 to the control unit 22 of the control system 20 for the textile machine 10 in order to enable or block access of the user 5.

FIG. 4 shows another exemplary embodiment of the method 100 and system 1 according to the invention. In this exemplary embodiment, the system 1 comprises a textile machine 10, a control system 20 comprising a monitoring unit 21 and a control unit 22, and an authentication system 30. The system 1 also has a sensor unit 40 and an interface 45, which communicatively connects the two communication networks 50, 60 to one another.

In contrast to FIG. 2 and FIG. 3, the sensor unit 40 in this example is located in the first communication network 50, i.e., the sensor unit 40, the textile machine 10 and the control system 20 are in the first communication network 50. As shown in all exemplary embodiments, the first communication network 50 can, for example, be a machine network, which, as a wired or wireless communication network, is in the form of an Ethernet and/or a WLAN and/or ZigBee and/or Bluetooth network.

According to FIG. 4, the exemplary embodiment of the method 100 according to the invention comprises the following steps.

First, a user 5 logs on to the sensor unit 40 with their “company card”, that is to say, the sensor unit 40, which can be in the form of a card reader, for example, acquires the identification data of the user 5 and, in a next step, transmits this data as an authentication request to the monitoring unit 21 of the control system 20. In a further step, the monitoring unit 21 of the control system 20 transmits the authentication request via the interface 45 to the authentication system 30 into the second communication network 60 to carry out the authentication. The authentication system 30 checks the received authentication request and decides upon enabling or blocking access of the user 5. In a next step, the authentication system 30 sends the authentication information relating to the decision to enable or block access back to the control system 20, for example to the monitoring unit 21, via the interface 45. Subsequently, the monitoring unit 21 or the control system 20 enables or blocks access of the user 5. The monitoring unit 21 transmits a corresponding control command to the control unit 22 to enable or block access of the user 5 to the textile machine 10.

FIG. 5 shows another exemplary embodiment of the method 100 according to the invention and system 1 according to the invention. In this exemplary embodiment, the system 1 comprises a textile machine 10, a control system 20 and an authentication system 30. The control system comprises a monitoring unit 21 and a control unit 22. The system 1 also has a sensor unit 40 and an interface 45, which communicatively connects the two communication networks 50, 60 to one another. In contrast to FIG. 3 and FIG. 4, the sensor unit 40 in this example is located in the first communication network 50, i.e., the sensor unit 40 and the textile machine 10 are in the first communication network 50.

FIG. 5 comprises another exemplary embodiment of the method 100 according to the invention. In one step, the authentication system 30 transmits authentication information to the monitoring unit 21 of the control system 20 initially or at the request of the control system 20. The authentication information comprises one or more authorization profiles for the user 5 for access, it being possible, for example, for each authorization profile to define a scope and/or configuration of the access for the particular user 5, for example for controlling different functions of the textile machine 10. The authentication information can be in the form of a communication message, for example.

According to this exemplary embodiment, if a user 5 then logs on to the sensor unit 40 of the textile machine 10, for example a card reader, for example with their “company card” in the form of a chip card or smart card, i.e., the card reader acquires the identification data of the user 5, the authentication request comprising this identification data is subsequently transmitted to the monitoring unit 21 of the control system 20. According to this exemplary embodiment, the monitoring unit 21 of the control system 20 uses the authentication information received from the authentication system 30 and the authorization profiles contained therein to check and decide upon the access of the user 5, i.e., upon enabling or blocking said access.

Alternatively, after receiving the authentication request, the monitoring unit 21 can also send a request to the authentication system 30 in order to obtain current authentication information. The monitoring unit 21 can subsequently decide upon access on the basis of the authentication information received.

Optionally, in all of the aforementioned exemplary embodiments, the authentication system 30 can have a database which comprises data for authenticating the at least one user 5 for access, for example access and/or authorization profiles for the at least one user 5.

The foregoing explanation of embodiments describes the present invention by way of example only. Of course, individual features of the embodiments can be freely combined with each other, if technically useful, without departing from the scope of the present invention.

### LIST OF REFERENCE SIGNS

1 System
5 User
10 Textile machine
20 Control system
21 Monitoring unit
22 Control unit
30 Authentication system
40 Sensor unit
45 Interface
50 First communication network
60 Second communication network
100 Method
101 First method step
102 Second method step
103 Third method step
104 Fourth method step

1. A system for access control comprising:
a textile machine and a control system for monitoring and controlling the textile machine, the control system comprising a monitoring unit and a control unit for monitoring and controlling the textile machine;
the textile machine and the control system being arranged in a first communication network for transmitting control commands for monitoring and controlling the textile machine; and
an authentication system being arranged in a second communication network, and the authentication system being designed to authenticate at least one user in order to enable access for controlling the textile machine in the first communication network.

2. The system according to claim 1, further including:
a sensor unit for acquiring identification data of the at least one user for authentication, the sensor unit being arranged in the first or in the second communication network.

3. The system according to claim 2, wherein:
the sensor unit is in the second communication network and is designed to transmit the acquired identification data to the authentication system for authentication, and/or the sensor unit is in the first communication network and is designed to transmit the acquired identification data to the authentication system for authentication or to the control system for authentication.

4. The system according to claim 2, wherein:
the sensor unit has a card reader and/or a fingerprint scanner and/or a retina scanner and/or a camera having face recognition and/or voice recognition.

5. The system according to claim 1, further including:
an interface which communicatively connects the textile machine and/or the control system in the first communication network to the authentication system in the second communication network, and the interface is designed to transmit authentication information from the authentication system to the textile machine and/or to the control system in order to enable or block control access for the at least one user.

6. The system according to claim 5, wherein:
the interface has a conversion unit which is designed to convert a data format and/or a network protocol of the authentication information when transmitted between the first communication network and the second communication network for setting production parameters for the textile machine.

7. The system according to claim 5, wherein:
the authentication information comprises a communication message relating to enabling or blocking access of the at least one user for controlling the textile machine and/or a communication message comprising one or more authorization profiles for the at least one user for an access, each authorization profile defining a scope and/or configuration of the access for the at least one user.

8. The system according to claim 1, wherein:
the authentication system has a database which comprises data for authenticating the at least one user for access.

9. The system according to claim 1, wherein:
the textile machine is a spooler or spinning machine, the textile machine having a plurality of work stations arranged side by side, which are each designed to carry out at least one production step for producing a textile product, control of the textile machine by the control system comprising at least one of the following actions in order to make the at least one of the following actions available to the at least one user in event of access being enabled:
setting at least one parameter of the textile machine;
setting at least one parameter of the work stations;
setting at least one parameter for production;
starting the textile machine;
setting a spinning means, a yarn parameter, a piecing parameter, a winding parameter or a cleaner parameter of the textile machine;
displaying measurement results from at least one sensor of the textile machinery;
activating or deactivating individual work stations; and
calling up a graphical user interface for the textile machine.

10. The system according to claim 1, wherein:
the first communication network is a higher level communication network, and the second communication network is a machine communication network of the textile machine, the machine communication network being designed as a separate communication network to the first communication network and/or being subordinate to the first communication network and/or being designed as a sub-network of the first communication network, and/or the first and/or the second communication network comprises a wired and/or wireless communication network.

11. A method for accessing control for the system according to claim 1, comprising the following steps:
receiving an authentication request by the authentication system in the second communication network, the authentication request being used to request authentication of the at least one user in order to enable access to the textile machine for the at least one user;
checking the received authentication request with respect to an access authorization of the at least one user;
granting access for the at least one user if the access authorization is confirmed by a check; and
transmitting to the textile machine and/or to the control system and/or to a sensor unit the granting of access of the at least one user.

12. The method according to claim 11,
comprising the following steps:
denying access for the at least one user for controlling the textile machine if the access authorization was rejected by the check;
the following step being carried out in event of denial:
transmitting to the textile machine and/or to the control system and/or to the sensor unit a blocking of access for the at least one user.

13. The method according to claim 11, comprising at least one of the following steps:
transmitting to the textile machine and/or to the control system and/or to the sensor unit authentication information for authenticating access of the at least one user, the authentication information comprising a communication message relating to enabling or blocking access of the at least one user to the textile machine;
transmitting authentication information for authenticating the access of the at least one user to the control system, the authentication information comprising a communication message which comprises one or more access authorization profiles for the at least one user for evaluation by the control system;
acquiring identification data of the at least one user by the sensor unit, the acquired identification data being specific to an identification of the at least one user to an authorization profile or access profile for controlling different functions of the textile machine and/or the control system; and
transmitting the acquired identification data to the authentication system for authentication.

14. A computer program, comprising commands which, when the computer program is executed by a computer, cause the computer to carry out the method according to claim 11.

15. A device for data processing, in arranged at least partly in an authentication system and/or in a control system of the system according to claim 1, comprising means for carrying out a method comprising:
receiving an authentication request by the authentication system in the second communication network, the authentication request being used to request authentication of at least one user in order to enable access to the textile machine for the at least one user;
checking the received authentication request with respect to an access authorization of the at least one user;
granting access for the at least one user if the access authorization is confirmed by the check; and
transmitting to the textile machine and/or to the control system and/or to a sensor unit the granting of access of the at least one user.

16. The system according to claim 1, wherein the authentication system is designed to authenticate the at least one user in order for the at least one user to set and/or configure production parameters for the textile machine.
